(19) United States
(12) Patent Application Publication
(10) Pub. No.: US 2010/0080379 A1
(43) Pub. Date: Apr. 1, 2010

(54) INTELLIGIBILITY BOOST

(76) Inventors: Shaohai Chen, Cupertino, CA (US); Phillip George Tamchina, Mountain View, CA (US); Chad G. Seguin, Morgan Hill, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/242,260

(22) Filed: Sep. 30, 2008

(51) Int. Cl. H04M 1/00

(52) U.S. Cl. 379/390.01

(57) ABSTRACT

A user of a communications device is given the ability to conveniently control the quality of the sound he is hearing during a call. An acoustic transducer interface circuit of the device has volume settings that are set by the user actuating a volume adjustment button or switch. In addition, the device has one or more intelligibility boost settings that are also selected by actuating the volume adjust button. Once the device has been signaled into the highest volume setting in response to actuation of the button in a given direction, and the next actuation of the button is also in the given direction, a downlink voice signal processor of the device responds to the next actuation by changing its audio frequency response to boost intelligibility of the far end user's speech being heard by the near end user. Other embodiments are also described and claimed.

An embodiment of the invention relates to improving a user's experience of downlink audio in a communications device. Other embodiments are also described.

### BACKGROUND

Two-way voice conversations (which may be not just voice only, but also voice and video) can be carried out between two users, using electronic communication devices such as telephones. These devices have evolved over the years from simple plain old telephone system (POTS) analog wire line stations to cellular network phones, smart mobile phones, voice over IP (VOIP) stations, and personal computer-based VOIP telephony applications. There is a desire to remain backwards compatible with the original, relatively small bandwidth allocated to a voice channel in a POTS network. This in part has prevented the emergence of a “high fidelity” telephone call, despite the availability of such technology.

Improving the sound quality of a telephone call is particularly desirable for mobile phones as they may be more susceptible to electromagnetic interference, due to their reliance on cellular wireless links. In addition, mobile phones are often used in noisy sound environments, such as outside in the wind or near a busy highway or a crowded people venue. Accordingly, modern communications devices such as mobile phones have one or more stages of audio signal processing that is applied to the downlink voice signal, which is received from the communications network (before the signal is audiblized to the near end user of the device through a speaker). Such processing or filtering may, for example, reduce the effect of echo and noise that might otherwise be heard by the near end user. Typically, while the near end user can adjust the volume of the speaker, there is no manual adjustment available for changing filtering in one audio frequency band relative to another, in the downlink voice path.

### SUMMARY

In accordance with the embodiments of the invention, a user of a communications device is given the ability to conveniently control the quality of the sound he is hearing during a call. In one embodiment, an acoustic transducer interface circuit (e.g., part of an audio codec integrated circuit device) of the communications device has volume settings that span a range between lowest and highest and are set by the user actuating a volume adjustment button. In addition, the device has one or more intelligibility boost settings. The intelligibility boost settings are also selected by actuating the volume adjust button of the device. In particular, once the device has been signaled into the highest volume setting in response to actuation of the button in a given direction, and the next actuation of the button during the call is also in the given direction, a downlink voice signal processor of the device responds to the next actuation by changing its audio frequency response to boost intelligibility of the far end user's speech being heard by the near end user.

The volume settings and the intelligibility boost settings may be signaled in the “host device” by the user's actuation of any one of a variety of different volume control buttons (and their associated switches or transducers). Examples include: a dedicated volume switch that is integrated in the housing of the host device; a switch that is integrated in a microphone housing of a wired headset and that is detected or read using a chipset that communicates with the host device through the microphone bias line; and a switch that is integrated in a wireless headset and that is detected or read using a short distance wireless interface chipset (e.g., a Bluetooth transceiver chipset) of the host device.

In another embodiment, the communications device has a touch sensitive screen in which a virtual volume button is displayed during the call. In particular, the virtual button may appear during speakerphone mode and not during handset mode. Once the device has been signaled into the highest volume setting, e.g. in response to actuation of the virtual button in a given direction, and the next actuation of the virtual button during the call is also in the same direction, the downlink processor responds by changing its frequency response in the audio range so as to boost intelligibility of speech that is heard from the loudspeaker of the device (in the speakerphone mode).

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a block diagram of a communications device with intelligibility boost settings, in operation during a call.

FIG. 2 is a diagram of a communications device having a display with a touch sensitive screen, in operation during a call.

FIG. 3 is a prospective, outside view of the housing of an example mobile communications device in which the intelligibility boost capability may be implemented.

FIG. 4 is a detailed block diagram of the mobile device of FIG. 3.

### DETAILED DESCRIPTION

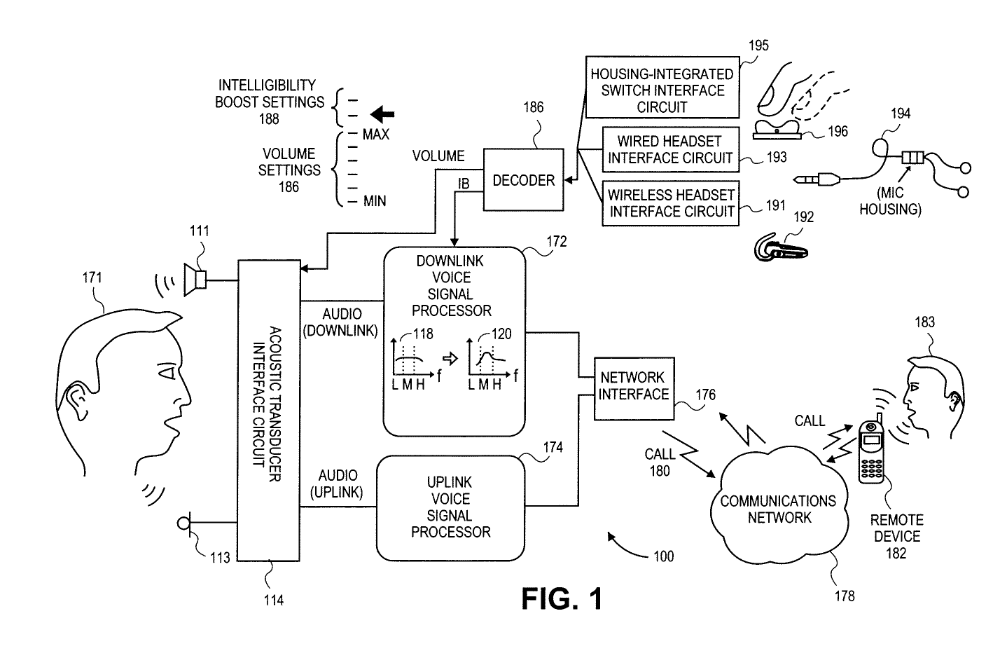

FIG. 1 is a block diagram of an example communications device with intelligibility boost, IB, settings, in operation during a call. The device 100 has a housing (not shown) in which are integrated the components depicted in FIG. 1. An acoustic transducer interface circuitry 114 is to feed an audio signal to and connect with an electro acoustic transducer or speaker 111. The acoustic transducer interface circuitry 114, which may be implemented in part within an audio codec integrated circuit device, may have a digital to analog converter followed by an audio amplifier, to convert a digital audio signal at an input of the codec device 114 into an analog speaker driver signal at an output of the interface circuitry 114. Alternatively, the acoustic transducer interface circuitry 114 may simply buffer and connect the audio signal to a wireless or wired headset interface (e.g., Bluetooth compliant interface circuitry, and circuitry to sense multiple switches through a microphone bias line of a wired headset). A downlink voice signal processor 172 has an input coupled to a communications network 178 and an output coupled to the acoustic transducer interface circuit 114.

The acoustic transducer interface circuit 114 is to feed an audio signal from, and connect with, a voice pickup device or microphone 113. For this function, the interface circuit 114, may have an analog to digital converter that converts the analog audio signal from a connected microphone 113 into digital form. Alternatively, the interface circuit 114 may simply buffer a digital audio signal from a digital, wireless or wired headset interface (e.g., as part of a Bluetooth wireless headset chipset or a microphone bias line remote sensing chipset). An uplink voice signal processor 174 is coupled between the communications network 178 and the interface circuit 114.

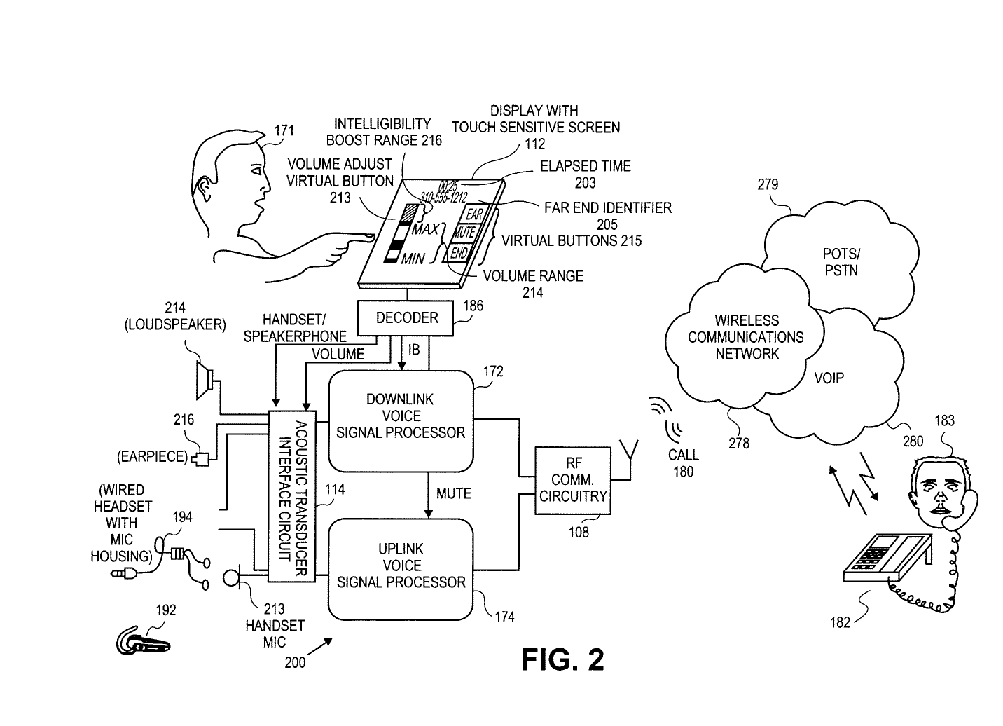

The speaker 111 may be a loudspeaker 214 used in speakerphone mode (see FIG. 2) or it may be an earpiece speaker or receiver 216 (see FIG. 2), both of which would be integrated in the communications device housing. As an alternative, the speaker 111 and microphone 113 (which are in use during the call) may be integrated in a headset (not shown). The headset, which may be a wired or wireless headset, would be connected to receive downlink audio (and send uplink audio) through an appropriate headset interface circuit (not shown) in the interface circuit 114.

Returning to FIG. 1, the device 100 supports a two-way voice conversation that may be part of a voice call or a video call, collectively referred to as a call 180, that has been established between a near end user 171 of the device 100, and a far end user 183 of a remote device 182. The call 180 may be established and conducted through a network interface 176 of the device 100. The network interface 176 may include the circuitry and software needed to, for example, place or receive the call 180 through a wire line connection with the public switched telephone network (PSTN). As an alternative, the network interface 176 may have the circuitry and software needed to conduct the call 180 as a wireless, cellular network call. In yet another embodiment, the network interface 176 may place or initiate the call 180 using a voice over Internet Protocol (VOIP) connection, through a wired or wireless local area network.

The call 180 may be placed or initiated through a communication network 178 to which the network interface is connected. Depending upon the particular type of remote device 182 used by the far end user 183, the communications network 178 may actually be composed of several different types of networks that cooperate with each other (e.g., via gateways, not shown) to establish and conduct the call 180. For example, the communications network 178 may include a cellular network link at the near end, followed by a back haul or PSTN segment and finally a wireless or wired local area network segment at the far end.

Once the call 180 has been established or a connection has been made with the remote device 182, processing of the users' conversation may proceed as follows. A downlink voice signal from the remote device 182 of the far end user 183 is received through network interface 176 and processed by downlink voice signal processor 172 prior to being delivered to the acoustic transducer interface circuitry 114. The downlink processor 172 may include digital audio signal processing capability in the form of hardware and/or software that applies a number of quality improvement operations to the input voice signal from the network interface 176, including, for example, echo cancellation and/or noise suppression. Similarly, and simultaneously, the uplink signal processor 174 may be applying echo cancellation and/or noise suppression to the microphone pickup signal, and then delivering the improved uplink signal to the network interface 176, which in turn transmits the signal to the communications network 178. The uplink signal eventually makes its way to the remote device 182 where it is audiblized for the end user 183.

The interface circuit 114 may have a number of volume settings 186 at which the speaker 111 is to be operated during the call. These settings span a range, between a lowest or minimum volume setting and a highest or maximum volume setting. A volume setting (or control signal) is provided to the interface circuit 114 by a decoder 186. The interface circuit 114 may include a local audio amplifier that responds to the volume setting by amplifying the audio signal received from the downlink processor 172 accordingly, before feeding the amplified audio signal to the speaker 111 over a wired connection. In another embodiment, the interface circuit 114 in effect forwards this volume setting to a remote audio amplifier, such as one that is located in a wireless headset. In that case, the audio signal is amplified by the remote audio amplifier, in accordance with the volume setting.

Still referring to FIG. 1, the decoder 186 may decode the user's actuation of any one of a variety of different volume control or adjust buttons (and their associated switches or mechanical to electrical transducers) into the specific volume settings 186 and IB settings 188. The decoder 186 may have logic circuitry and storage that keeps track of the current setting (volume or IB), and then updates the current setting based on the next detected switch actuation. Alternatively, the decoder 186 may be implemented as a programmed processor running a software component that responds to incoming interrupt signals that have been sourced from various interface circuits 191, 193, 195, as described below.

In one example, a dedicated volume switch 196 that is integrated in the housing of the host device may be detected or read by the decoder 186, through a housing-integrated switch interface circuit 195 (e.g., a simple switch biasing circuit). The switch 196 is depicted as a momentary rocker switch that is to be actuated during a call by the user's finger. In this case, the user can push or pull the switch 195 in one direction to signal the interface circuit 114 into a lower volume setting, and in an opposite direction to signal the interface circuit into a higher volume setting. Thus, each pushing or pulling of the switch 196 in a given direction will change to the next higher (or lower) volume setting. As an alternative to a rocker switch, a click wheel or rotary switch may be used for setting the volume.

There may also be a volume switch located in the microphone housing of a wired headset 194. The headset 194 may be connected to the (host) device 100 through a standard headset jack (not shown). In that case, a wired headset interface 193 of the device 100 contains part of a chipset that detects or reads the switch through the microphone bias line, and then provides this information to the decoder 186.

In yet another embodiment, a volume switch is integrated in a wireless headset 192. For that case, a wireless headset interface 191 of the (host) device 100 contains part of a short distance wireless interface chipset (e.g., a Bluetooth transceiver chipset) that detects or reads the switch through a wireless link with the host device 100. The decoder 186 could be alerted by the chipset, e.g. through an interrupt signal, in response to each switch actuation.

Once the downlink processor 172 has been signaled into the highest volume setting in response to actuation in a given direction, and next actuation is also in the same direction, the downlink processor 172 will respond to this next actuation by changing its frequency response. The frequency response, which is in the audio frequency range, is that to which the downlink voice signal is subjected before being fed to the speaker interface circuit. In one embodiment, the change increases gain over a middle frequency band, M, relative to lower and upper frequency bands, L and H, as shown. Once the decoder 186 detects the maximum volume setting, the next actuation at that point is translated into an IB setting, which is signaled to the downlink processor 172. In other words, as seen in FIG. 1, the next time the user's finger pushes or pulls on the switch in the same direction as is done to increase the volume, the signal processor 172 enters the first intelligibility boost setting 188. In this setting, the frequency response of the signal processor changes from being essentially flat or balanced (balanced frequency response 118), into one that is emphasizing the middle frequency band (IB frequency response 120) in order to increase intelligibility of human speech being heard by the near end user 171 through the speaker 111. From the user's point of view, this occurs when he has, for example, pushed the volume adjust button several times to raise the volume during the call, but then continues to push the button beyond the maximum volume setting, in an effort to better hear the far end user speaking during the call. The latter automatically places the downlink signal processor 172 into an intelligibility boost setting 188, in which its frequency response to the downlink audio signal is changed in a manner that results in boosting intelligibility of speech that is delivered from the interface circuit 114 to the near end user 171.

As depicted in FIG. 1, in one embodiment, the frequency response of the downlink signal processor 172 changes from a balanced or flat shape 118 into one that has increased gain over a middle frequency band, M, relative to lower, L, and upper, H, frequency bands that are below and above it, respectively (reference 120). As an example, the middle frequency band M may be within a range of 1.5 kHz to 2.5 kHz. In another embodiment, the middle frequency band M is within a range of 2 kHz to 4 kHz. In those cases, the L and H frequency bands are, respectively, below the lower limit of the M band and above its higher limit. Other numerical ranges that may boost intelligibility of speech in the particular communication device 100 are, alternatively, possible.

In addition to increasing the gain in the middle frequency band M, relative to the lower and upper frequency bands, the downlink signal processor 172 may be designed to further respond to an intelligibility boost setting 188, by increasing roll off in the lower frequency band, L, as depicted in the frequency response curves shown in FIG. 1. In other words, an intelligibility boost frequency response 120 may have increased roll off in its L band, relative to the L band in a flat or balanced frequency response 118. More generally, the increase in gain of the M band may be accompanied by simultaneous gain decreases in the L and/or H bands, to maintain the overall output acoustic energy or power (of the speaker 111) about the same as that which was being delivered at the maximum volume setting. All of the changes in frequency response described here may be achieved by, for example, changing the coefficients of a digital filter that is operating on the downlink voice signal.

FIG. 1 also shows that there may be more than one intelligibility boost setting 188. In that case, as the user continues to actuate (e.g., repeats a button push) the switch in the same direction (that is in the direction of higher volume), the decoder 186 detects this further actuation and signals a subsequent intelligibility boost setting 188 to the downlink signal processor 172. The latter responds by further changing its frequency response, for example by further increasing the gain over the middle frequency band relative to the lower and upper frequency bands and/or further increasing roll off in the lower frequency band. From the point of view of the user 171, this may occur when the user continues to push a volume adjustment button, in the direction of increased volume, perhaps because he is still not able to adequately hear the voice of the far end user 183.

In many instances, the near end user 171 may decide during the call that the volume through the speaker 111 is too high and will, therefore, actuate the volume adjust button in the direction of decreasing volume. In that case, actuation of the transducer 185 in the direction of lower volume (starting from the setting maximum) will signal the downlink signal processor 172 to exit the intelligibility boost state and resume a “normal” volume (somewhere between minimum and maximum). The downlink signal processor 172 may, in that case, respond by changing its frequency response back to the balanced or flat shape 118.

When the call has ended, the downlink processor 172 may be automatically signaled to return to some normal volume setting, in preparation for the next call to be placed or received. For example, a telephony module (not shown) may be running in the device 100 and that is responsible for managing calls, including signaling the network interface 176 to place a new call or disconnect an on-going call, and receiving a signal from the network interface 176 that a new call has been received or that an ongoing call has been disconnected. This information may be signaled to the downlink processor 172 to cause it to “reset”, i.e. deactivate the intelligibility boost and instead resume some normal volume setting, at the beginning of each new call.

Turning now to FIG. 2, a diagram of a communications device 200 is shown that uses a display with a touch sensitive screen 112 that displays virtual buttons or switches, for use by the user in invoking call functions during a call. The particular device 200 here has RF communications circuitry 108 that is coupled to an antenna, so that the near end user 171 can place or receive a wireless call through a wireless communications network 278. The call 180 with the far end user 183 and his remote device 182 may, as was described above in connection with the communications network 178 of FIG. 1, span multiple, different types of network segments, including, for example, a POTS/PSTN 279 and/or a VOIP network 280. The RF communication circuitry 108 may include in this case not only RF transceiver circuitry but also, for example, a cellular baseband processor to enable the call 180 as a cellular network call. Alternatively, the RF communication circuitry 108 may enable the call 180 to be a wireless VOIP call, wherein that case the wireless communications network 278 may be a wireless local area network.

The downlink signal processor 172 has an input that is coupled to the wireless communication network 278 through the RF circuitry 108 and the antenna, and an output that is alternatively coupled to an earpiece speaker or receiver 216 in handset mode, and a loudspeaker 214 in speakerphone mode. The downlink voice signal from the downlink processor 172 is fed to the acoustic transducer interface circuit 114. The interface circuit 114 may in part be integrated with a codec, so as to perform the function of converting the digital downlink voice signal into analog form, amplify the analog signal in accordance with the volume setting signaled by the decoder 186, and route the analog signal to either the loudspeaker 214 or the earpiece 216 depending upon whether the device 200 is operating in speakerphone mode or headset mode. The order of conversion, amplification and routing by this combination may be different. Note that as an alternative, when the wireless headset 192 has been activated, the interface circuit 114 can simply buffer the downlink voice signal and route it to the wireless headset interface circuit 191, which may be a wireless digital headset interface such as one that is compliant with Bluetooth technology (see FIG. 1). In yet another alternative, when a traditional wired headset has been connected, the interface circuit 114 may convert the downlink signal into analog form, amplify it, and then route it to a headset jack that is integrated into the housing of the device 200 and to which the wired headset is connected.

For the uplink side, the device 202 may have a similar arrangement as device 100, shown in FIG. 1, namely a similar uplink voice signal processor 174 whose output is fed to the RF circuitry 108 to be uploaded into the communications network 278. Input to the uplink signal processor 174 may come from a headset interface circuit (e.g., when a wired headset has been connected to a headset jack of the device 200, or an associated wireless headset has been enabled), or from a handset microphone 213 that is integrated into the housing of the device 200. Other ways of routing and converting the digital downlink and uplink voice signals between the signal processors 172, 174 and the microphones and speakers (acoustic transducers) that are connected to the device 200 are possible.

As in the embodiment of FIG. 1, in FIG. 2, the earpiece speaker 216 or loudspeaker 214 is to be operated at a number of different volume settings during a wireless call, between a minimum and a maximum (also referred to as the volume range 214). In this case, however, the decoder 186 detects signals from a display with a touch sensitive screen 112 (that may also be integrated in the housing of the device 200). A virtual volume adjust button or switch 213 is displayed by the screen 112, during speakerphone mode and not during the handset mode. This virtual button 213 has a volume range 214, which spans from a minimum to a maximum volume setting, and an intelligibility boost range 216 immediately beyond the maximum setting of the volume range 214. The near end user 171 sets the volume at which he can hear the far end user 183 during a call by, for example, touching a cursor that is part of the virtual button 213 and then sliding the cursor from between Min and Max to the desired volume, and then lifting off the cursor. Once the user 171 “actuates” the volume adjust button 213 by going beyond the maximum level during the call, the decoder 186 detects this and signals the downlink signal processor 172 to enter into an intelligibility boost setting (within the range 216). In other words, once the virtual button 213 is at its highest volume setting (in response to the user having placed it in that setting), the next actuation of the button during the call, in the direction of increasing volume, moves the cursor into the intelligibility boost range 216. The downlink processor 172 then responds to this by changing its frequency response so as to boost intelligibility of speech that is heard from the loudspeaker in the speakerphone mode.

The downlink signal processor 172 in this embodiment may also respond similarly as described above in connection with FIG. 1, by changing its frequency response from a balanced or flat shape 118 (which may be applicable to all of the volume settings within the volume range 214) to one that exhibits increased gain over a middle frequency band relative to lower and upper frequency bands (reference 120, see FIG. 1).

Although not explicitly described here, the process of initiating an outgoing call 180, or answering an incoming call 180, may be in accordance with a number of different possible techniques. For example, in the embodiment of FIG. 2 where the device 200 has touch sensitive screen 112, the call 180 (as an incoming call) can be answered by the user 171 simply touching (actuating) a virtual answer button displayed on the screen 112, while a ringing tone is playing through the loudspeaker 214. Once the call has been answered by the device 200, and a two-way voice conversation can take place with the far end user 183, the near end user 171 may wish to place the device 200 in speakerphone mode. FIG. 2 shows an example of such a situation, where the touch sensitive screen 112 displays elapsed time 203 of the call (for example, seconds and minutes), a far end identifier 205 (for example, the telephone number assigned to the remote device 182 where such can be obtained using an automatic number identification, ANI, protocol or a calling line ID, CLID, protocol), and a set of virtual buttons 215 that provide various call processing functions including switching between handset mode and speakerphone mode, a mute button that signals the uplink signal processor 174 to block the signal being delivered from the microphone interface circuit, and a call disconnect or end button. These may be in addition to the volume adjust virtual button 213, all of which may be displayed simultaneously on the touch sensitive screen 112.

The speakerphone mode aspects described above are also applicable to the instance where the call 180 is an outgoing call that has been placed by the near end user 171, for example, following a manual number dialing process using a virtual keypad (not shown) or by automatic dialing of a stored number associated with the name of the far end user 183 which has been selected from a contacts list stored in the device 200.

### Detailed Aspects of an Example Mobile Device

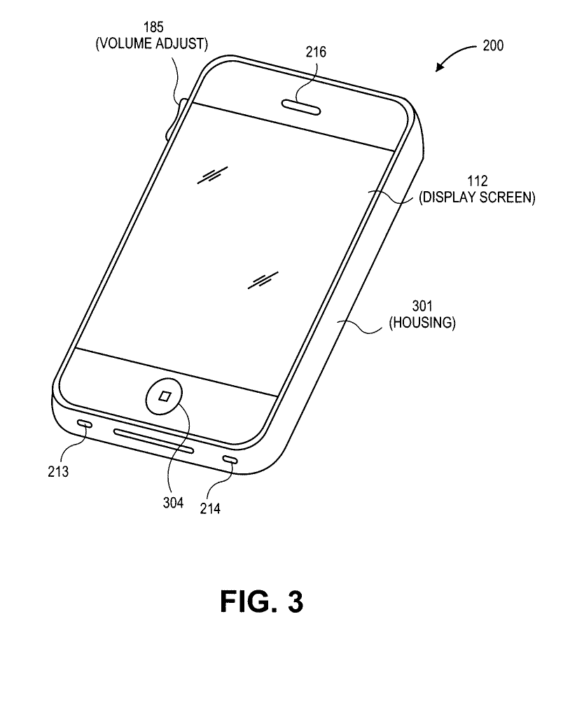

As suggested above, the embodiments of the invention may be particularly desirable in a mobile communications device, such as a mobile smart phone. FIG. 3 shows an example communications device 200, which is a mobile multi-function device or smart phone, in which an embodiment of the invention may be implemented. The device 200 has a housing 301 in which most of the components described in connection with FIGS. 1-2 and FIG. 4 are integrated. The housing holds the display screen 212 on the front face of the device 200. The display screen 212 may also include a touch screen. The device 200 may also include one or more physical buttons and/or virtual buttons (on the touch screen). In one embodiment, the button 19 is a physical button that when actuated by the user brings a graphical user interface of the device to its home or main menu, as performed for example by an iphone® device of Apple Inc. of Cupertino, Calif. The home menu may include a launch icon for a telephony application (not shown). Once launched by the user, the telephony application may show the user her contacts list from which the user can select a party to call. Alternatively, a virtual keypad may be displayed that allows the user to dial a number manually.

The device 200 includes input-output components such as handset microphone 213 and loudspeaker 214. When the speakerphone mode is not enabled, the sound during a telephone call is emitted from earpiece or receiver 216 that is placed adjacent to the user's ear during a call in the handset mode of operation. The device 200 may also include a headset jack (not shown) and a wireless headset interface, to connect with a headset device that has a built-in microphone, allowing the user to experience the call while wearing a headset that is connected to the device 200.

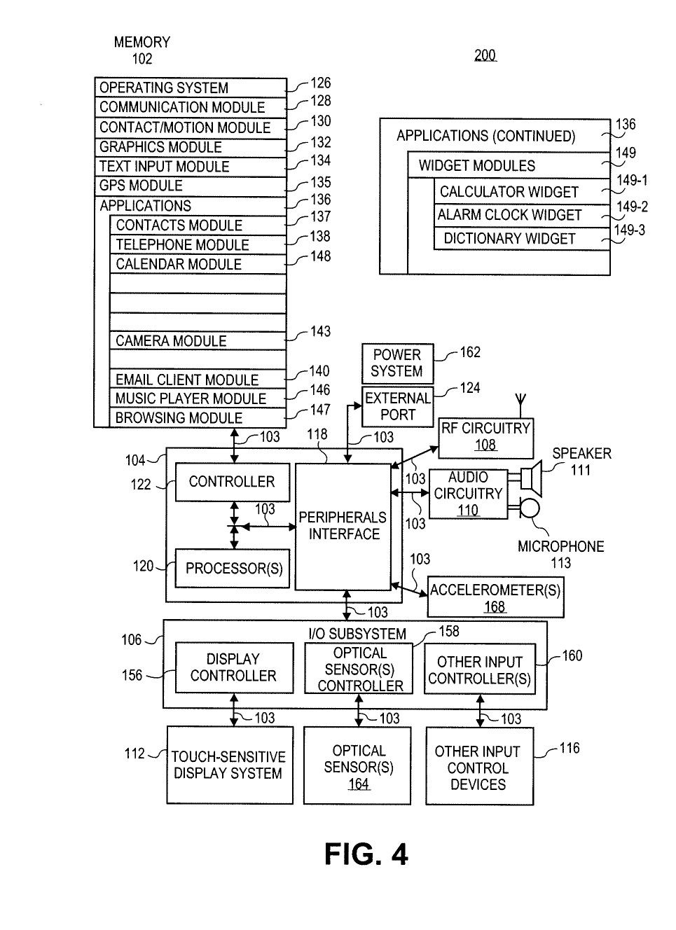

Referring to FIG. 4, a block diagram of the example device of FIG. 3 is shown. It is noted that not every embodiment of the invention requires the entire architecture illustrated in FIG. 4. The device 200 depicted here may be a portable wireless communications device such as a cellular telephone that also contains other functions such as wireless email access, wireless web browsing, digital media (music and/or movie) playback. The device 200 has memory 102 which may include random access memory, non-volatile memory such as solid state disk storage, flash memory, and/or other suitable digital storage. Access to the memory 102 by other components of the device, such as one or more processors 120 or peripherals interface 118, may be controlled by a memory controller 122. A peripherals interface 118 allows input and output peripherals of the device 200 to communicate with the processors 120 and memory 102. These components may be built into the same integrated circuit chip 104, or they may each be part of a separate integrated circuit package.

In one example, there are one or more processors 120 that run or execute various software programs or sets of instructions (e.g., applications) that are stored in memory 102, to perform the various functions described below, with the assistance of or through the peripherals. These may be referred to as modules stored in the memory 102. The memory 102 also stores an operating system 126 of the device. The operating system may be an embedded operating system such as Vx Works, OS X, or others which may also include software components and/or drivers for controlling and managing the various hardware components of the device, including memory management, power management, sensor management, and also facilitates communication between various software components or modules.

The device 200 may have wireless communications capability enabled by radio frequency (RF) circuitry 108 that receives and sends RF signals via an integrated or built-in antenna of the device 200. The RF circuitry may include RF transceivers, as well as digital signal processing circuitry that supports cellular network or wireless local area network protocol communications. The RF circuitry 108 may be used to communicate with networks such as the Internet with such protocols as the World Wide Web, for example. This may be achieved through either the cellular telephone communications network or a wireless local area network, for example. Different wireless communications standards may be implemented as part of the RF circuitry 108, including global system for mobile communications (GSM), enhanced data GSM environment (EDGE), high speed downlink packet access (HSDPA), code division multiple access (CDMA), Bluetooth, wireless fidelity (Wi-Fi), and Wi-Max.

The device 200 also includes audio circuitry 110 that provides an interface to acoustic transducers, such as the speaker 111 (e.g., a loudspeaker, an earpiece or receiver, a headset) and a microphone 113. These form the audio interface between a user of the device 200 and the various applications that may run in the device 200. The audio circuitry 110 serves to translate digital audio signals produced in the device (e.g., through operation of the processor 120 executing an audio-enabled application) into a format suitable for output to a speaker, and translates audio signals detected by the microphone 130 (e.g., when the user is speaking into the microphone) to digital signals suitable for use by the various applications running in the device.

The device 200 also has an I/O subsystem 106 that serves to communicatively couple various other peripherals in the device to the peripherals interface 118. The I/O subsystem 106 may have a display controller 156 that manages the low level processing of data that is displayed on the touch sensitive display screen 112. One or more input controllers 160 may be used to receive or send signals from and to other input control devices 116, such as physical switches or transducers (e.g., push button switches, rocker switches, etc.), dials, slider switches, joy sticks, click wheels, and so forth. In other embodiments, the input controller 160 may enable input and output to other types of devices, such as a keyboard, an infrared interface circuit, a universal serial bus, USB, port, or a pointer device such as a mouse. Physical buttons may include an up/down button for volume control of the speaker 111 and a separate, sleep or power on/off button of the device 200. In contrast to these physical peripherals, the touch sensitive screen 112 is used to implement virtual or soft buttons and one or more soft keyboards.

The touch sensitive screen 112 is part of a larger input interface and output interface between the device 200 and its user. The display controller 156 receives and/or sends electrical signals from/to the touch screen 112. The latter displays visual output to the user, for example, in the form of graphics, text, icons, video, or any combination thereof (collectively termed “graphics” or image objects). The touch screen 112 also has a touch sensitive surface, sensor, or set of sensors that accept input from the user based on haptic and/or tactile contact. These are aligned directly with the visual display, typically directly above the latter. The touch screen 112 and the display controller 156, along with any associated program modules and/or instructions in memory 102, detect contact, movement, and breaking of the contact on the touch sensitive surface. In addition, they convert the detected contact into interaction with user-interface objects (e.g., soft keys, program launch icons, and web pages) whose associated or representative image objects are being simultaneously displayed on the touch screen 112.

The touch screen 112 may include liquid crystal display technology or light emitting polymer display technology, or other suitable display technology. The touch sensing technology may be capacitive, resistive, infrared, and/or surface acoustic wave. A proximity sensor array may also be used to determine one or more points of contact with the touch screen 112. The touch screen 112 may have a resolution in excess of 100 dpi. The user may make contact with the touch screen 112 using any suitable object or appendage, such as a stylist, a finger, and so forth. In some embodiments, the user interface is designed to work primarily with finger-based contacts and gestures, which are generally less precise than stylist-based input due to the larger area of contact of a finger. The device in that case translates the rough finger-based input into a precise pointer/cursor position or command for performing the action desired by the user.

The device 200 has a power system 162 for supplying electrical power to its various components. The power system 162 may include a power management system, one or more replenishable or rechargeable power sources such as a battery or fuel cell, a replenishing system, a power or failure detection circuit, as well as other types of circuitry including power conversion and other components associated with the generation, management and distribution of electrical power in a portable device.

The device 200 may also include one or more accelerometers 168. The accelerometer 168 is communicatively coupled to the peripherals interface 118 and can be accessed by a module being executed by the processor 120. The accelerometer 168 provides information or data about the physical orientation or position of the device, as well as rotation or movement of the device about an axis. This information may be used to detect that the device is, for example, in a vertical or portrait orientation (in the event the device is rectangular shaped) or in a horizontal or landscape orientation. On that basis, a graphics module 132 and/or a text input module 134 are able to display information “right side up” on the touch screen 112, regardless of whether the device is in any portrait or landscape orientation. The processing of the accelerometer data may be performed by the operating system 126 and in particular a driver program that translates raw data from the accelerometer 168 into physical orientation information that can be used by various other modules of the device as described below.

The device 200 shown in FIG. 4 may also include a communication module 128 that manages or facilitates communication with external devices over an external port 124. The external port 124 may include a universal serial bus port, a fire wire port, or other suitable technology, adapted for coupling directly to an external device. The external port 124 may include a multi-pin (e.g., a 30 pin) connector and associated circuitry typically used for docking the device 200 with a desktop personal computer.

Turning now to the modules in more detail, a contact/motion module 130 may detect user initiated contact with the touch screen 112 (in conjunction with the display controller 156), and other touch sensitive devices e.g., a touchpad or physical quick wheel. The contact/motion module 130 has various software components for performing operations such as determining if contact with the touch screen has occurred or has been broken, and whether there is movement of the contact and tracking the movement across the touch screen. Determining movement of the point of contact may include determining speed (magnitude), velocity (magnitude and direction), and/or acceleration of the point of contact. These operations may be applied to single contacts (e.g., one finger contacts) or to multiple simultaneous contacts (e.g., multi-touch or multiple finger contacts).

The graphics module 132 has various known software components for rendering and displaying graphics on the display of the touch screen 112 including, for example, icons of user interface objects such as soft keys and a soft keyboard. The text input module 134, which may be a component of graphics module 132, provides soft keyboards for entering text in different languages. Such soft keyboards are for use by various applications e.g., a telephone module 138, a contacts module 137 (address book updating), email client module 140 (composing an email message), browsing module 147 (typing in a web site universal resource locator), and a translation module 141 (for entering words or phrases to be translated).

A GPS module 135 determines the geographic location of the device (using for example an RF-based triangulation technique), and provides this information for display or use by other applications, such as by the telephone module 138 for user in location-based dialing and applications that provide location-based services, such as a weather widget, local Yellow Page widget, or map/navigation widgets (not shown). The widget modules 149 depicted here include a calculation widget 149_1 which displays a soft keypad of a calculator and enables calculator functions, an alarm clock widget 149_2, and a dictionary widget 149_3 that is associated or tied to the particular human language set in the device 200.

The telephone module 138 is responsible for managing the placement of outbound calls and the receiving of inbound calls made over a wireless telephone network, e.g. a cellular telecommunications network. Some or all of the functions of the decoder 186 described above in connection with FIG. 1 and FIG. 2 may be implemented by a processor 120 executing appropriate software components in the telephone module 138.

A calendar module 148 displays a calendar of events and lets the user define and manage events in her electronic calendar.

A music player module 146 may manage the downloading, over the Internet or from a local desktop personal computer, of digital media files, such as music and movie files, which are then played back to the user through the audio circuitry 110 and the touch sensitive display system 112.

It should be noted that each of the above-identified modules or applications correspond to a set of instructions to be executed by a machine such as the processor 120, for performing one or more of the functions described above. These modules or instructions need not be implemented as separate programs, but rather may be combined or otherwise rearranged in various combinations. For example, the text input module 134 may be integrated with the graphics module 132. In addition, the enablement of certain functions could be distributed amongst two or more modules, and perhaps in combination with certain hardware. For example, in one embodiment, the functions of the decoder 186 (see FIG. 2) might be distributed across the following components: circuitry that interfaces with the touch screen 112, the contact/motion module 130, and the telephone module 138.

To conclude, various aspects of a technique for giving a user of a communications device more convenient control of sound quality have been described. As explained above, an embodiment of the invention may be a machine-readable medium having stored thereon instructions which program a processor to perform some of the operations described above. In other embodiments, some of these operations might be performed by specific hardware components that contain hardwired logic. Those operations might alternatively be performed by any combination of programmed data processing components and fixed hardware circuit components.

A machine-readable medium may include any mechanism for storing or transferring information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). The invention is not limited to the specific embodiments described above. For example, the device 200 depicted in FIG. 2 has a telephony device with wireless call capability may be a mobile telephony device (e.g., a smart phone handset) or it may be a desktop personal computer running a VOIP telephony application program. Accordingly, other embodiments are within the scope of the claims.

What is claimed is:

1. An apparatus comprising:
a communications device housing having integrated therein
an acoustic transducer interface circuit,
a downlink voice signal processor having an input to be coupled to a communications network and an output coupled to the acoustic transducer interface circuit,
the interface circuit to have a plurality of volume settings at which a speaker is to be operated during a call through the network, including a lowest volume setting and a highest volume setting,
a decoder to sense actuation of a mechanical to electrical transducer, during the call, in one direction as signaling a lower volume setting and in an opposite direction as signaling a higher volume setting,
wherein once the highest volume setting has been signaled in response to actuation of the transducer in said opposite direction, and the decoder senses next actuation of the transducer during the call is also in said opposite direction, the decoder is to signal the downlink processor to respond to said next actuation by changing its frequency response.

2. The apparatus of claim 1 wherein the downlink processor is to change its frequency response so as to increase gain over a middle frequency band relative to lower and upper frequency bands.

3. The apparatus of claim 2 wherein the middle frequency band is within a range of 1.5 kHz to 2.5 kHz.

4. The apparatus of claim 2 wherein the middle frequency band is within a range of 2 kHz to 4 kHz.

5. The apparatus of claim 2 wherein said increase of gain over the middle frequency band, relative to the lower and upper frequency bands, results in boosting intelligibility of speech that is delivered from the speaker interface circuit during the call.

6. The apparatus of claim 1 wherein the downlink processor is to respond to said next actuation by changing its frequency response from a balanced or flat shape to one that has increased gain over a middle frequency band relative to lower and upper frequency bands.

7. The apparatus of claim 6 wherein the downlink processor further responds to said next actuation by increasing roll off in the lower frequency band.

8. The apparatus of claim 6 wherein the downlink processor further responds to said next actuation by decreasing gain over lower and/or upper frequency bands, so that overall energy or power output by the speaker interface circuit in an intelligibility boost setting is no greater than in a maximum volume setting.

9. The apparatus of claim 1 further comprising a receiver integrated in the housing and to which the interface circuit is connected during the call, while the apparatus is in a handset mode, wherein the receiver is said speaker.

10. The apparatus of claim 1 further comprising a loudspeaker integrated in the housing and to which the interface circuit is connected during the call, while the apparatus is in a speakerphone mode, wherein the loudspeaker is said speaker.

11. The apparatus of claim 1 further comprising a wireless headset to which the interface circuit is connected during the call, wherein the speaker is integrated in the wireless headset.

12. The apparatus of claim 1 further comprising a wired headset to which the interface circuit is connected during the call, wherein the speaker is integrated in the wired headset.

13. The apparatus of claim 1 further comprising the speaker being integrated in the communications device housing.

14. The apparatus of claim 1 wherein the downlink processor is to respond to a further actuation of the transducer in said one direction, which signals a resumption of volume setting between the lowest volume setting and the highest volume setting, by changing its frequency response to a balanced or flat shape.

15. The apparatus of claim 2 wherein the downlink processor is to respond to a further actuation of the transducer in said opposite direction, by changing its frequency response so as to further increase gain over the middle frequency band relative to the lower and upper frequency bands.

16. The apparatus of claim 1 further comprising a wireless headset interface circuit, wherein the decoder is to sense actuation of the mechanical to electrical transducer through the wireless headset interface circuit.

17. The apparatus of claim 1 further comprising a wired headset interface circuit, wherein the decoder is to sense actuation of the mechanical to electrical transducer through the wired headset interface circuit.

18. The apparatus of claim 1 further comprising the speaker the mechanical to electrical transducer, being integrated in said communications device housing.

19. An apparatus comprising:
a mobile telephony device housing having integrated therein
a touch sensitive screen,
RF communications circuitry coupled to an antenna,
a downlink voice signal processor having an input to be coupled to a wireless communications network through the RF communications circuitry and the antenna, and an output to be coupled to a speaker that is to be operated at a plurality of volume settings during a wireless call through the network,
a virtual button that is to be displayed on the touch sensitive screen and that is to be actuated in one direction during the call to signal a lower volume setting and in an opposite direction to signal a higher volume setting,
wherein once signaled into the highest volume setting in response to actuation of the button in said opposite direction, and next actuation of the button during the call is also in said opposite direction, the downlink processor is to respond to said next actuation by changing its frequency response.

20. The apparatus of claim 19 wherein the downlink processor is to change its frequency response so as to boost intelligibility of speech that is heard from the speaker, without increasing overall energy or power output, from the speaker, relative to the highest volume setting.

21. The apparatus of claim 19 wherein the downlink processor is to change its frequency response, in response to said next actuation of the button, from a balanced or flat shape at all said plurality of volume settings to one that exhibits increased gain over a middle frequency band relative to lower and upper frequency bands.

22. The apparatus of claim 21 wherein the middle frequency band is within a range of 1.5 kHz to 2.5 kHz.

23. The apparatus of claim 21 wherein the middle frequency band is within a range of 2 kHz to 4 kHz.

24. The apparatus of claim 19 wherein the downlink processor is to respond to a further actuation of the button in said one direction, which signals a resumption of volume setting between the lowest volume setting and the highest volume setting, by changing its frequency response to a balanced or flat shape.

25. The apparatus of claim 21 wherein the downlink processor is to respond to a further actuation of the button in said opposite direction, by changing its frequency response so as to further increase gain over the middle frequency band relative to the lower and upper frequency bands.

26. The apparatus of claim 21 wherein the virtual button is to be displayed in speakerphone mode and not handset mode, and the speaker is a loudspeaker integrated in the device housing. 27. A communications device comprising:
means for processing a downlink voice signal; and
means for adjusting a volume setting for the downlink voice signal to be heard though a speaker, between a lowest volume setting and a highest volume setting, and
wherein actuation of the volume setting adjustment means, from the highest volume setting to an intelligibility boost setting, is to cause the downlink voice signal processing means to change its frequency response that is applied to the downlink voice signal.
